(19) United States
(12) Patent Application Publication
(10) Pub. No.: US 2012/0001998 A1
(43) Pub. Date: Jan. 5, 2012

(54) IMAGE FORMING APPARATUS AND CONTROL METHOD OF IMAGE FORMING APPARATUS

(75) Inventor: Hidehito Sasaki, Tokyo (JP)

(73) Assignees: Toshiba Tec Kabushiki Kaisha, Tokyo (JP); Kabushiki Kaisha Toshiba, Tokyo (JP)

(21) Appl. No.: 13/174,667

(22) Filed: Jun. 30, 2011

Related U.S. Application Data
(60) Provisional application No. 61/361,338, filed on Jul. 2, 2010.

(51) Int. Cl. B41J 2/435

(52) U.S. Cl. 347/224

(57) ABSTRACT

There is provided with an image forming apparatus, which includes: a laser output unit that outputs laser light; a rotary polygon mirror that reflects the laser light output from the laser output unit; a photoconductor where the laser light reflected from the rotary polygon mirror is incident to scan; and a controller that corrects the written position of laser light on the photoconductor in a first state where the amount of laser light output from the laser output unit is a first amount of light and a second state where the amount of laser light is larger than the first amount of light, by controlling emission timing of the laser output unit.

### CROSS-REFERENCE TO RELATED APPLICATION

This application is also based upon and claims the benefit of priority from U.S. provisional application 61/361338, filed on Jul. 2, 2010; the entire contents of which are incorporated herein by reference.

### FIELD

Embodiments described herein relate generally to a technology of correcting a written position of a photoconductor in an image forming apparatus.

### BACKGROUND

There is an image forming apparatus that reflects emitted light output from a laser diode, using a polygon mirror, and is equipped with a scanning optical system that scans a photoconductive drum, using the reflected light. Such a type of image forming apparatus is equipped with a position detecting sensor that acquires the information on the written position of the light emitted to scan the photoconductive drum. Further, in this type of image forming apparatus, the amount of laser light may be increased to eliminate any inconvenience due to a deterioration of the sensitivity of the photoconductive drum. As the amount of laser light increases, the pulse width of the output signal of the position detecting sensor changes, such that there is concern that the written position in the main scanning direction may deviate.

### DESCRIPTION OF THE DRAWINGS

FIG. 1 is a cross-sectional view showing the internal configuration of a color digital complex machine.

FIG. 2 is a schematic configuration view of a light beam scanning unit.

FIG. 3 is a graph schematically showing the corresponding relationship between the life of a photoconductive drum and the amount of laser light.

FIG. 4 is a diagram showing the intensity of output signals output from a photoelectric conversion element in a beam position detecting sensor, which is the output intensity of three lasers with different the amount of laser light.

FIG. 5 is a diagram corresponding to FIG. 4, showing output of a pulse signal.

FIG. 6 is a schematic view schematically showing positional deviation of data.

FIG. 7 is a schematic view schematically showing the relationship between the amount of light and At.

FIG. 8 is a functional block diagram of an image forming apparatus.

FIG. 9 is a flowchart showing a correction method of correcting an written position of a laser output unit.

FIG. 10 is a flowchart showing a correction method of correcting an written position of a laser output unit (modified example 1).

### DETAILED DESCRIPTION

An image forming apparatus according to the embodiment includes: a laser output unit that outputs laser light; a rotary polygon mirror that reflects the laser light output from the laser output unit; a photoconductor where the laser light reflected from the rotary polygon mirror is scanned; and a controller that corrects the written position of laser light on the photoconductor in a first state where the amount of laser light output from the laser output unit is a first amount of light and a second state where the amount of laser light is larger than the first amount of light, by controlling the emission timing of the laser output unit.

Hereinafter, an image forming apparatus according to the embodiment will be described in detail with reference to the drawings.

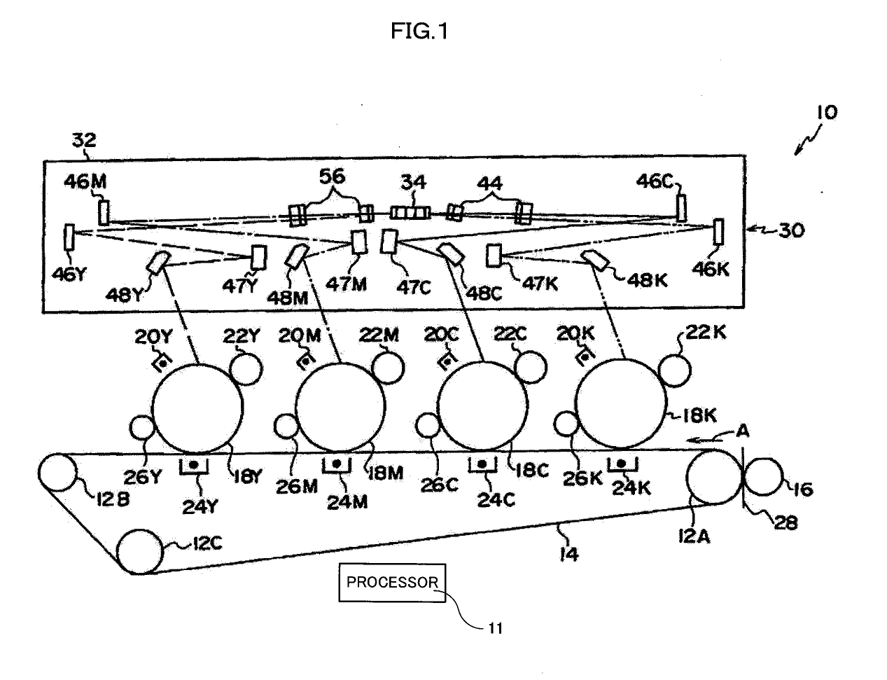

FIG. 1 is a cross-sectional view of a color image forming apparatus that is an image forming apparatus according to the embodiment. However, some components required for description are perspectively shown. A color image forming apparatus 10 includes a feeding roller 12A to 12C, a transfer belt 14 wound and held on the feeding rollers 12A to 12C, and a transfer roller 16 opposite to the feeding roller 12A with the transfer belt 14 therebetween. A processor 11 is in charge of the overall control of the color image forming apparatus 10.

Photoconductive drums 18K to 18Y are disposed above the transfer belt 14, in the movement direction (the direction of an arrow A in FIG. 1) of the transfer belt 14 when the transfer belt 14 is driven to rotate. The photoconductive drum 18K is for black (K). The photoconductive drum 18C is for cyan (C). The photoconductive drum 18M is for magenta (M). The photoconductive drum 18Y is for yellow (Y). Hereafter, the components installed for the K, C, M, and Y colors are given the symbols K/C/M/Y attached to their respective reference numeral for discrimination.

Chargers 20 that charge the photoconductive drums 18 are positioned around the photoconductive drums 18, respectively. A plurality of beam scanning apparatuses 30, which forms electrostatic latent images on the photoconductive drums 18 by irradiating laser beams onto the charged photoconductive drums 18, is positioned above the photoconductive drums 18, respectively.

A developing device 22, a transferring device 24, and a cleaning device 26 are positioned around each of the photoconductive drums 18. The developing device 22 forms a toner image by developing the electrostatic latent image formed on the photoconductive drum 18 with a predetermined color (K, C, M, or Y) of toner.

The transferring device 24 transfers the toner image formed on the photoconductive drum 18 onto the transfer belt 14. The cleaning device 26 removes the toner left on the photoconductive drum 18.

The different color toner images formed on the photoconductive drums 18 are transferred onto the belt surface of the transfer belt 14, overlapping each other. Accordingly, a color toner image is formed on the transfer belt 14 and the color toner image formed is transferred onto a transfer material 28 conveyed in between the feeding roller 12A and the transfer roller 16. Further, the transfer material 28 is conveyed to a fixing device (not shown) and the transferred toner image is fixed. Accordingly, a color image (full color image) is formed on the transfer material 28.

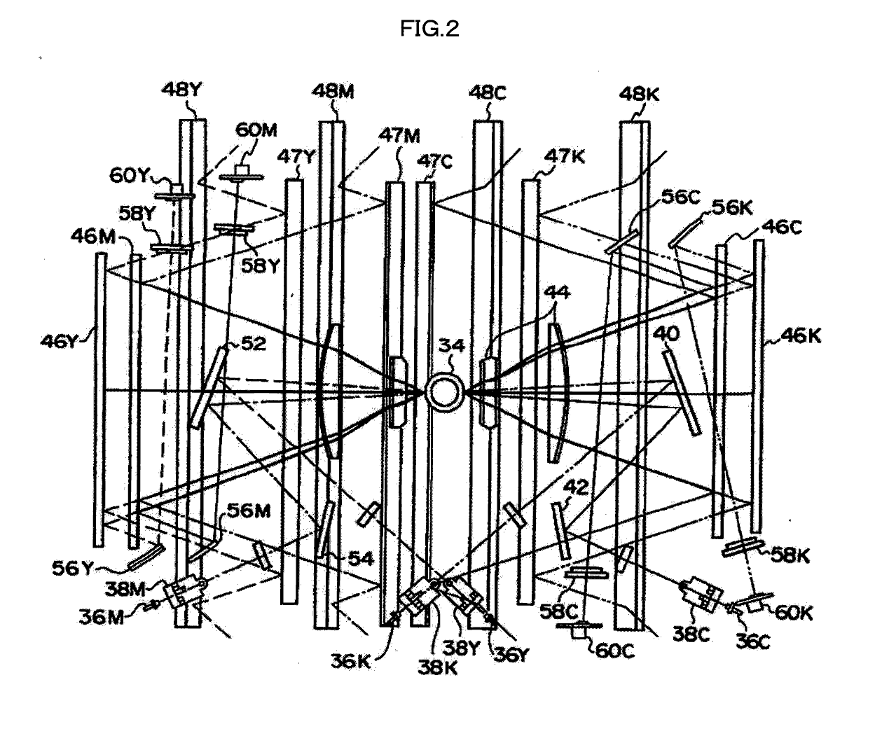

Next, the plurality of beam scanning apparatuses 30 is described with reference to FIG. 1 and FIG. 2. FIG. 2 is a schematic configuration view of the plurality of beam scanning apparatuses. The plurality of beam scanning apparatus 30 has a casing and a rotary polygon mirror 34 is positioned substantially at the center portion of the casing. The rotary polygon mirror 34 is rotated at high speed by a motor (not shown). Laser diodes 36M, 36K, 36Y, and 36C that emit laser light that is irradiated to the photosensitive drums are sequentially positioned from one end to the other end of the casing, at a side in the casing.

A collimator lens 38K and a plane mirror 40 are sequentially positioned at the laser light emission side of the laser diode 36K. Laser beam K emitted from the laser diode 36K is made be a parallel light flux by the collimator lens 38K and incident on the plane mirror 40. Further, a collimator lens 38C and a plane mirror 42 are sequentially positioned at the laser light emission side of the laser diode 36C, such that laser beam C emitted from the laser diode 36C is made be a parallel light flux by the collimator lens 38C, and then is reflected from the plane mirror 42 and incident on the plane mirror 40.

An fθ lens 44 is positioned between the plane mirror 40 and the rotary polygon mirror 34, such that the laser beam K and the laser beam C, which reflect from the plane mirror 40, are incident on the rotary polygon mirror 34 through the fθ lens 44, reflected and biased by the rotary polygon mirror 34, and then pass through the fθ lens 44 again.

The laser diode 36K and the laser diode 36C are different in position in the axial direction (corresponding to the sub-scanning direction) of the rotary polygon mirror 34, such that the laser beam K and the laser beam C are incident on the rotary polygon mirror 34 at different incident angles in the sub-scanning direction. Therefore, the laser beams K and C passing through the fθ lens 44 two time are incident on different plane mirrors 46K and 46C.

Further, the laser beam K reflected by the plane mirror 46K, as shown in FIG. 1, is reflected from a plane mirror 47K and incident on a cylindrical mirror 48K, reflects from the cylindrical mirror 48K toward the photoconductive drum 18K, and is incident on the circumferential surface of the photoconductive drum 18K to scan. Further, the laser beam C reflected by the plane mirror 46C is incident on a cylindrical mirror 48C after being reflected by a reflective mirror 47C, reflects from the cylindrical mirror 48C toward the photoconductive drum 18C, and is incident on the circumferential surface of the photoconductive drum 18C to scan.

Meanwhile, a collimator lens 38Y and a plane mirror 52 are sequentially positioned at the laser light emission side of the laser diode 36Y, such that laser beam Y emitted from the laser diode 36Y is made be a parallel light flux by the collimator lens 38Y and incident on a plane mirror 52. Further, a collimator lens 38M and a plane mirror 54 are sequentially positioned at the laser light emission side of the laser diode 36M, such that laser beam M emitted from the laser diode 36M is made be a parallel light flux by the collimator lens 38M, and then is reflected from the plane mirror 54 and incident on the plane mirror 52.

An fθ lens 43 is positioned between the plane mirror 52 and the rotary polygon mirror 34, such that the laser beam Y and the laser beam M, which reflect from the plane mirror 52, are incident on the rotary polygon mirror 34 through the fθ lens 43, reflected and biased by the rotary polygon mirror 34, and then pass through the fθ lens 43 again.

The laser diode 36Y and the laser diode 36M are different in position in the axial direction (corresponding to the sub-scanning direction) of the rotary polygon mirror 34, such that the laser beam Y and the laser beam M are incident on the rotary polygon mirror 34 at different incident angles in the sub-scanning direction, and accordingly, the laser beams C and M passing through the fθ lens 43 two times are incident on different plane mirrors 46Y and 46M.

Further, the laser beam Y reflected by the plane mirror 46Y is reflected by a reflective mirror 47Y and then incident on a cylindrical mirror 48Y, reflects from the cylindrical mirror 48Y toward the photoconductive drum 18Y, and is incident on the circumferential surface of the photoconductive drum 18Y to scan. Further, the laser beam M reflected by the plane mirror 46M is incident on a cylindrical mirror 48M after being reflected by a reflective mirror 47M, reflects from the cylindrical mirror 48M toward the photoconductive drum 18M, and is incident on the circumferential surface of the photoconductive drum 18M to scan. Since the laser beam K and C, the laser beam Y and M are incident on the surfaces of the rotary polygon mirror 34 opposite to each other, the laser beam K and C, the laser beam Y and M are scanned in the reverse direction.

Further, a return mirror 56K is disposed at the position corresponding to the SOS (Start Of Scan) in the scanning range of the laser beam K, of the plane mirror 46K, at the side from which the laser beam K reflects, and a lens 58K and a beam position detecting sensor 60K are sequentially positioned at the side, of the return mirror 56K from which the laser beam K reflects. The laser beam K emitted from the laser diode 36K is reflected from the return mirror 56 and incident on the beam position detecting sensor 60K, when the reflective surface among the reflective surfaces of the rotary polygon mirror 34 which reflects the laser beam K, is positioned in the direction in which incident light is reflected in a direction corresponding to the SOS.

Similarly, a return mirror 56C is disposed at the position corresponding to the SOS in the scanning range of the laser beam C, of the plane mirror 46C, at the side from which the laser beam C reflects and a lens 58C and a beam position detecting sensor 60C are sequentially positioned at the side from which the laser beam K reflects, of the return mirror 56C. Further, a return mirror 56M is disposed at the position corresponding to the SOS in the scanning range of the laser beam M, at the side of the plane mirror 46M, from which the laser beam M reflects, and a lens 58M and a beam position detecting sensor 60M are sequentially positioned at the side from which the laser beam M reflects, of the return mirror 56M. Further, a return mirror 56Y is disposed at the position corresponding to the SOS in the scanning range of the laser beam Y of the plane mirror 46Y, at the side from which the laser beam Y reflects, and a lens 58Y and a beam position detecting sensor 60Y are sequentially positioned at the side, from which the laser beam Y reflects, of the return mirror 56Y.

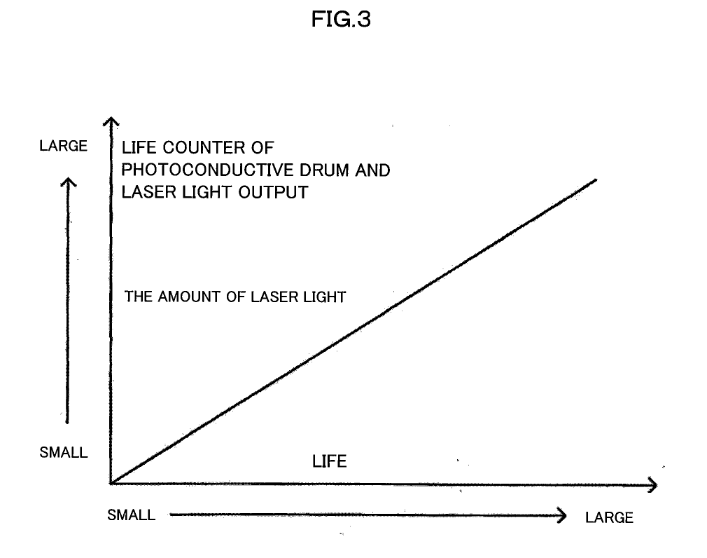

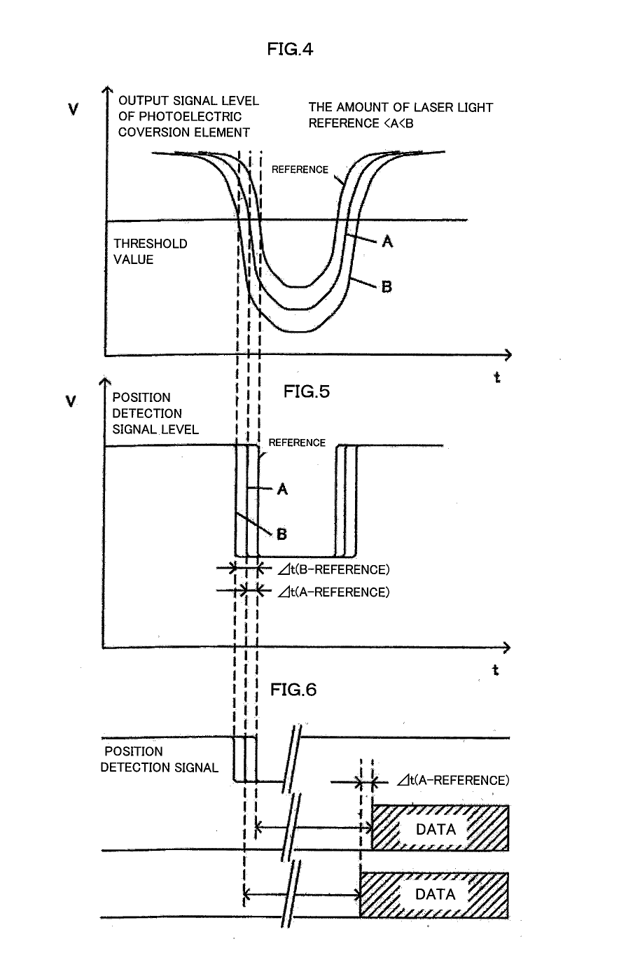

In this configuration, since the sensitivity of the photoconductive drum 18 changes over time, control of increasing the amount of laser light that is irradiated to the photoconductive drum 18 is performed. FIG. 3 is a graph schematically showing the corresponding relationship between the life of a photoconductive drum and the amount of laser light. FIG. 4 shows the intensity of output signals output from a photoelectric conversion element in a beam position detecting sensor 60, which is the output intensity of three lasers with different amount of laser light. The beam position detecting sensor 60 outputs a pulse signal, when the intensity of an output signal exceeds a threshold value. FIG. 5 is a diagram corresponding to FIG. 4, showing the output of a pulse signal.

In the figures, the amount of laser light increases in the order of a reference level, a level A, and a level B. The written positions change in the main scanning direction on the photoconductive drum 18, when the amount of laser light is different. For example, when the deterioration of the photoconductive drum 18K is higher than that of the photoconductive drum 18Y, the output of a laser of the laser diode 36K is higher than that of the laser diode 36Y. In this case, since the written position of the laser beam output from the laser diode 36K is deviated, it is required to appropriately correct the written position. In detail, as shown in FIG. 6, as the output of the laser diode 36 increases from the reference level to the level A, the written position of data makes a positional deviation as much as Δt. Therefore, it is required to advance the output timing of the laser diode 36K with improved output, by Δt from the reference level.

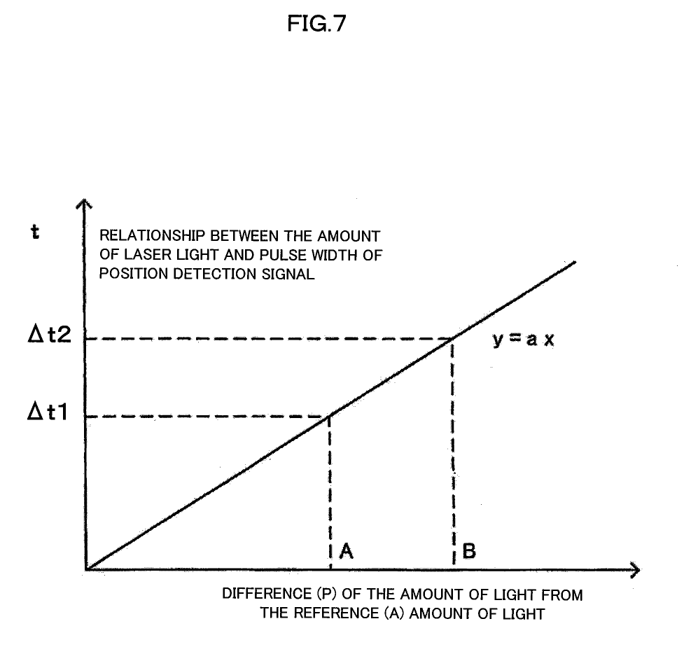

FIG. 7 is a schematic view schematically showing the relationship between the amount of light and Δt. The relationship between the amount of light and Δt may be a linear equation prescribed by y=ax. A proportional constant a can be obtained by experiments or simulation. As can be see from FIG. 7, when the output of the laser diode 36 increases from the reference level to the level A, the output timing of the laser diode 36 may be advanced by Δt1. When the output of the laser diode 36 increases from the reference level to the level B, the output timing of the laser diode 36 may be advanced by Δt2.

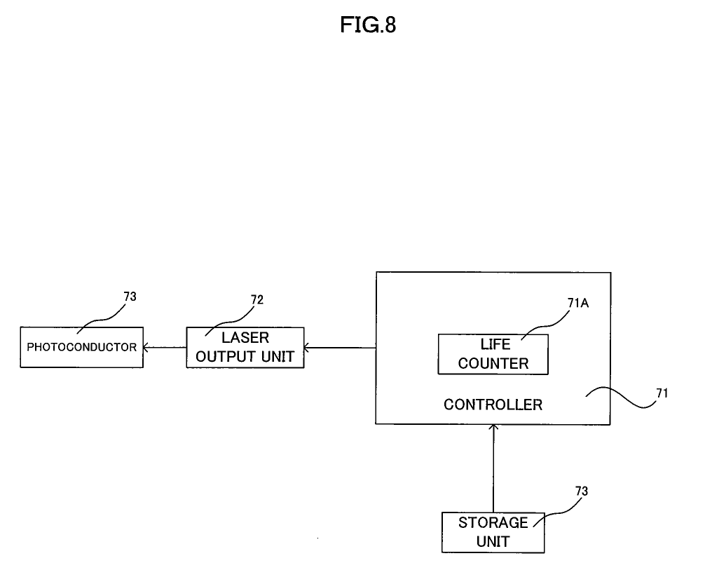

Next, an image forming apparatus according to the embodiment is described with reference to functional block diagram of FIG. 8. A controller 71 includes a life counter (acquiring unit) 71A that counts the use time of a photoconductor. The controller 71 increases the output of a laser output unit 72, when the number of count of the life counter 71A becomes a predetermined value. A storage unit 73 stores the relationship between the intensity of laser output and the laser emission timing. In detail, the storage unit 73 stores emission timing control data shown in FIG. 7. The data format of the emission timing control data may be a data table or the type of a functional formula.

The controller 71 corrects the written position on the photoconductor 73 by advancing the emission timing of the laser output unit 72 on the basis of the emission timing control data stored in the storage unit 73, when increasing the output of the laser output unit 72. The corresponding relationship between the hard configuration of FIG. 1 and the functional block of FIG. 8 is described. The photoconductor 73 may be the photoconductive drums 18K to 18Y. When the photoconductor 73 is the photoconductive drum 18K, the laser output unit 72 may be the laser diode 36K. When the photoconductor 73 is the photoconductive drum 18M, the laser output unit 72 may be the laser diode 36M. When the photoconductor 73 is the photoconductive drum 18C, the laser output unit 72 may be the laser diode 36C. When the photoconductor 73 is the photoconductive drum 18Y, the laser output unit 72 may be the laser diode 36Y.

The controller 71 may be the processor 11. However, the controller 71 may be an ASIC circuit that performs at least a portion of a process to perform, in a circuit type.

Further, the storage unit 73 may be implemented by cooperation of an HDD and a memory.

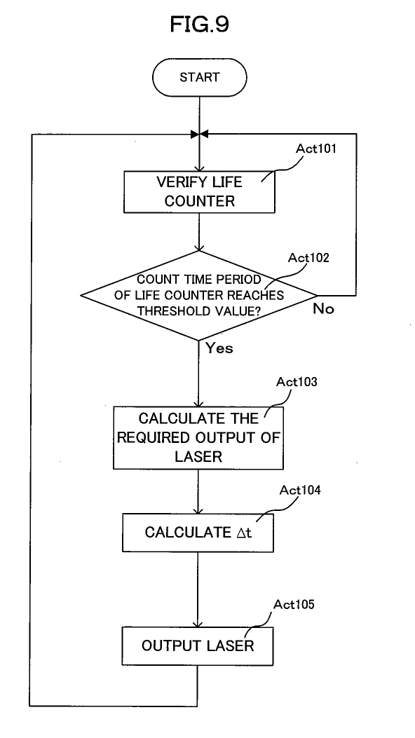

Next, a correcting method of correcting the written position of the laser output unit is described with reference to the flowchart of FIG. 9. In the embodiment, the correcting method of the written position is described by exemplifying the laser diode 36K. In Act 101, the controller 71 verifies the count time period of the life counter 71A. In Act 102, the controller 71 determines whether the count time period of the life counter 71A reaches a threshold value. The threshold value may be a design value that is set in accordance with the deterioration of the photoconductive drum 18Y. When the count time period of the life counter 71A reaches the threshold value, the process proceeds to Act 103, or when the count time period of the life counter 71A does not reach the threshold value, the process returns to Act 101.

In Act 103, the controller 71 calculates the required output of the laser diode 36K. In this case, by storing the relationship between the count time period of the life counter 71A and the required output of the laser diode 36K, as a data table, in the storage unit 73, it may be possible to calculate the required output of the laser diode 36K on the basis of the relation information stored in the storage unit 73.

In Act 104, the controller 71 calculates Δt relating to the emission timing of the laser diode 36K from the required output of the laser diode 36K, which is obtained in Act 103, on the basis of the emission timing control data stored in the storage unit 73. In Act 105, the controller 71 advances the emission timing of the laser diode 36k by Δt, which is obtained in Act 104. The written position is corrected by advancing the emission timing of the laser diode 36K.

### Modified Example 1

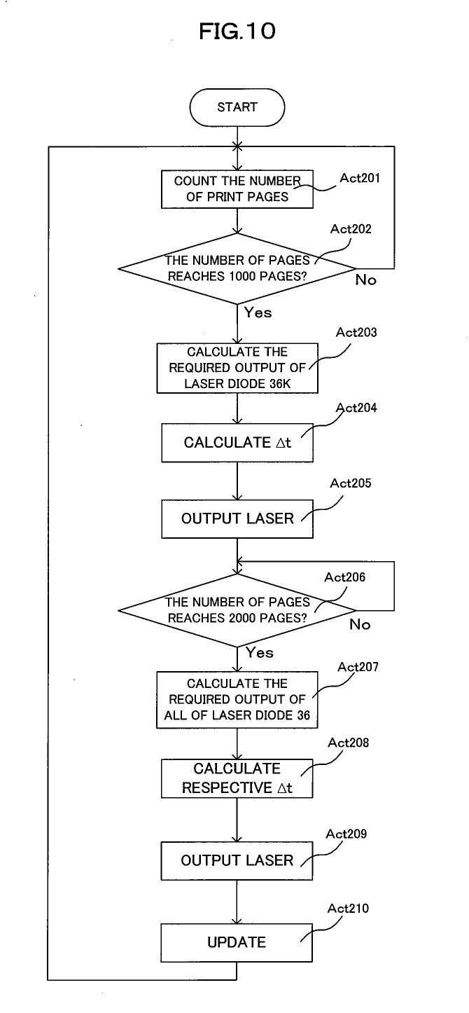

Although the output timing of the laser diodes 36 is controlled in accordance with the use time of the photoconductive drums 18, respectively, in the embodiment described above, other methods may be available. Another method is described with reference to the flowchart of FIG. 10. When the frequency of usage of the black toner is higher than the frequency of usage of other color toner, the deterioration of the photoconductive drum 18K relatively increases. In this case, the output of the laser diode 36K corresponding to the photoconductive drum 18K is increased at a timing earlier than other laser diodes 36 corresponding to the other photoconductive drums 18.

In Act 201, the controller 71 starts to count the number of print pages. In Act 202, the controller 71 determines whether the number of print pages reaches 1000 pages. Here, 1000 pages is an example, however the number of print pages is not limited thereto. That is, the number of print pages maybe appropriately changed, according to deterioration speed of the laser diode 36K.

In Act 203, the controller 71 calculates the required output of the laser diode 36K. In this case, by storing the relationship between the number of print and the required output of the laser diode 36K, as a data table, in the storage unit 73, it may be possible to calculate the required output of the laser diode 36K on the basis of the relationship information stored in the storage unit 73.

In Act 204, the controller 71 calculates Δt relating to the emission timing of the laser diode 36K from the required output of the laser diode 36K, which is obtained in Act 203, on the basis of the emission timing control data stored in the storage unit 73. In Act 205, the controller 71 advances the emission timing of the laser diode 36k by Δt, which is obtained in Act 204. The written position is corrected by advancing the emission timing of the laser diode 36K.

In Act 206, the controller 71 determines whether the number of print pages reaches 2000 pages. Here, 2000 pages is an example, and the number of print pages is not limited thereto. That is, the number of pages may be appropriately changed in accordance with the deterioration of all of the laser diodes 36.

In Act 207, the controller 71 calculates the required output of all of the laser diodes 36. In this case, by storing the relationship between the number of print and the required output of all of the laser diodes 36, as a data table, in the storage unit 73, it may be possible to calculate the required output of each other laser diodes 36 on the basis of the relationship information stored in the storage unit 73.

In Act 208, the controller 71 calculates Δt relating to the emission timing of the laser diodes 36 from the required output of the laser diodes 36, which is obtained in Act 207, on the basis of the emission timing control data stored in the storage unit 73.

In Act 209, the controller 71 advances the emission timing of the laser diodes 36 by Δt, which is calculated in Act 208. The written position is corrected by advancing the emission timing of the laser diodes 36.

In Act 210, the controller 71 updates the counted number of print pages and returns to Act 201.

### Modified Example 2

Although the beam position detecting sensors 60 are installed for the laser diodes 36, respectively, in the embodiment described above, other configurations may be available. As another configuration, the beam position detecting sensors 60 corresponding to the laser diode 36K and the laser diode 36Y, respectively, may be installed. In this case, the beam position detecting sensors 60 corresponding to the laser diode 36M and the laser diode 36C are removed, and the beam position detection of the laser diode 36M is performed by the beam position detecting sensor 60 of the laser diode 36Y and the beam position detection of the laser diode 36C is performed by the beam position detection sensor 60 of the laser diode 36K. Accordingly, the intensity of laser output of the laser diode 36Y and the laser diode 36M is corrected at the same timing while the intensity of laser output of the laser diode 36C and the laser diode 36K is corrected at the same timing. Further, the laser output timing of the laser diode 36Y and the laser diode 36M is controlled to be the same and the laser output timing of the laser diode 36C and the laser diode 36K is controlled to be the same.

The present invention may be implemented in various ways without departing from the spirit or the principle characteristics. Therefore, the embodiments described above are just examples in all aspect and should not be construed as being limitative. The scope of the invention is defined by claims and is not limited to the specification. Further, all modifications, and various improvement, replacement, and variation pertaining to a range equivalent to claims are within the scope of the invention.

What is claimed is:

1. An image forming apparatus comprising:
a laser output unit that outputs laser light;
a rotary polygon mirror that reflects the laser light output from the laser output unit;
a photoconductor where the laser light reflected from the rotary polygon mirror is scanned; and
a controller that corrects the written position of laser light on the photoconductor in a first state where the amount of laser light output from the laser output unit is a first amount of light and a second state where the amount of laser light is larger than the first amount of light, by controlling emission timing of the laser output unit.

2. The apparatus of claim 1,
wherein a deterioration of the photoconductor is higher in the second state than the first state.

3. The apparatus of claim 2, further comprising:
an acquiring unit that acquires an estimation value to estimate the degradation of the photoconductor,
wherein the controller increases the amount of laser light of the laser output unit from the first amount of light to the second amount of light, when the estimation value acquired by the acquiring unit exceeds a threshold value.

4. The apparatus of claim 3,
wherein the estimation value is the use time of the photoconductor.

5. The apparatus of claim 3,
wherein the estimation value is the number of print pages.

6. The apparatus of claim 1,
wherein the controller advances the emission timing of the laser output unit in the second state than the first state.

7. The apparatus of claim 6, further comprising:
a storage unit that stores the relationship between the amount of laser light and the emission timing of the laser output unit,
wherein the controller controls the emission timing of the laser output unit on the basis of the information stored in the storage unit.

8. The apparatus of claim 7,
wherein the information stored in the storage unit is information that delays the emission timing of the laser output unit, as much as the increase of the amount of laser light from a reference level.

9. The apparatus of claim 8,
wherein the reference level is the amount of initial laser light irradiated to the photoconductor that is not used yet.

10. A control method of an image forming apparatus, comprising:
correcting the written position of laser light on a photoconductor in a first state where the amount of laser light output from a laser output unit is a first amount of light and a second state where the amount of laser light is larger than the first amount of light, by controlling emission timing of the laser output unit, when emitting the photoconductor by reflecting the laser light output from the laser output unit with a rotary polygon mirror and using the laser light reflected from the rotary polygon mirror.

11. The method of claim 10,
wherein a deterioration of the photoconductor is higher in the second state than the first state.

12. The method of claim 10,
wherein the amount of laser light of the laser output unit increases from the first amount of light to the second amount of light, when an estimation value to estimate a deterioration of the photoconductor exceeds a threshold value.

13. The method of claim 12,
wherein the estimation value is the use time of the photoconductor.

14. The method of claim 12,
wherein the estimation value is the number of print pages.

15. The method of claim 10,
wherein the emission timing of the laser output unit in the second state is advanced than the first state.

16. The method of claim 15,
wherein the emission timing of the laser output unit is controlled on the basis of information readout from a storage unit that stores the relationship between the amount of laser light and the emission timing of the laser output unit.

17. The method of claim 16,
wherein the information stored in the storage unit is information that delays the emission timing of the laser output unit, as much as the increase of the amount of laser light from a reference level.

18. The method of claim 17,
wherein the reference level is the amount of initial laser light irradiated to the photoconductor that is not used yet.
